(19) United States
(12) Patent Application Publication
(10) Pub. No.: US 2002/0074092 A1
(43) Pub. Date: Jun. 20, 2002

(54) Window shade

(75) Inventor: Chang Han Shen, Chang Hua Hsien (TW)

Correspondence Address: HARRISON and EGBERT, 412 MAIN STREET, 7th FLOOR, HOUSTON, TX, 77002, US

(73) Assignee: Gee Mei Handicraft Company Limited

(21) Appl. No.: 09/739,609

(22) Filed: Dec. 19, 2000

(51) Int. Cl. E06B 3/48

(52) U.S. Cl. 160/84.01

(57) ABSTRACT

A window shade is formed of a top rail, a pliable shade body, and a pull cord set. The top rail has an arresting member and two actuating members. The shade body is provided with a plurality of cross pleats, a middle tube, and a bottom tube. The middle tube is provided with a middle cross rod fitted thereinto. The bottom tube is provided with two bottom cross rods fitted thereinto. The shade body can be folded to have an ornamental form by the pull cord set in conjunction with the arresting member and the two actuating members.

### BACKGROUND OF THE INVENTION

1. Field of the Invention

The present invention relates generally to a window shade, and more particularly to a window shade having a versatile shade body.

2. Description of Related Art

The conventional window shades are generally monotonous in design at best. Such window shades do not give an added decorative effect to the room. The U.S. Pat. No. 5,207,257 discloses a window shade having a shade body which can be folded to have an ornamental form. However, this prior art window shade is defective in design in that its two pull cords must be pulled at the time when the shade body is folded, thereby resulting in a great deal of inconvenience in folding the window shade.

### BRIEF SUMMARY OF THE INVENTION

The primary objective of the present invention is to provide a window shade comprising a top rail, a pull cord set, and a pliable shade body. The top rail is provided with an arresting member and two actuating members. The shade body is provided with a plurality of cross pleats, which are connected with the pull cord set. The shade body is provided at the bottom side with a bottom tube into which two bottom cross rods are fitted. The shade body is further provided in the midsegment with a middle tube into which a middle cross rod is fitted. The shade body can be folded to have an ornamental shape by the pull cord set in conjunction with the arresting member and the actuating members of the top rail.

### BRIEF DESCRIPTION OF THE SEVERAL VIEWS OF THE DRAWINGS

FIG. 1 shows a perspective view of the present invention.

FIG. 2 shows an exploded view of the present invention.

FIG. 3 shows a sectional view of the pull cord set and the arresting member of the present invention.

FIG. 4 shows a sectional views of the pull cord set and the actuating members of the present invention.

FIG. 5 shows a sectional view of the pull cord set and the locating member of the present invention.

FIG. 6 shows a front view of the present invention in the unfolding state.

FIG. 7 shows a schematic view of the present invention being folded.

FIG. 8 shows a schematic view of the present invention which is partially folded.

FIG. 9 shows a schematic view of the present invention which is completely folded.

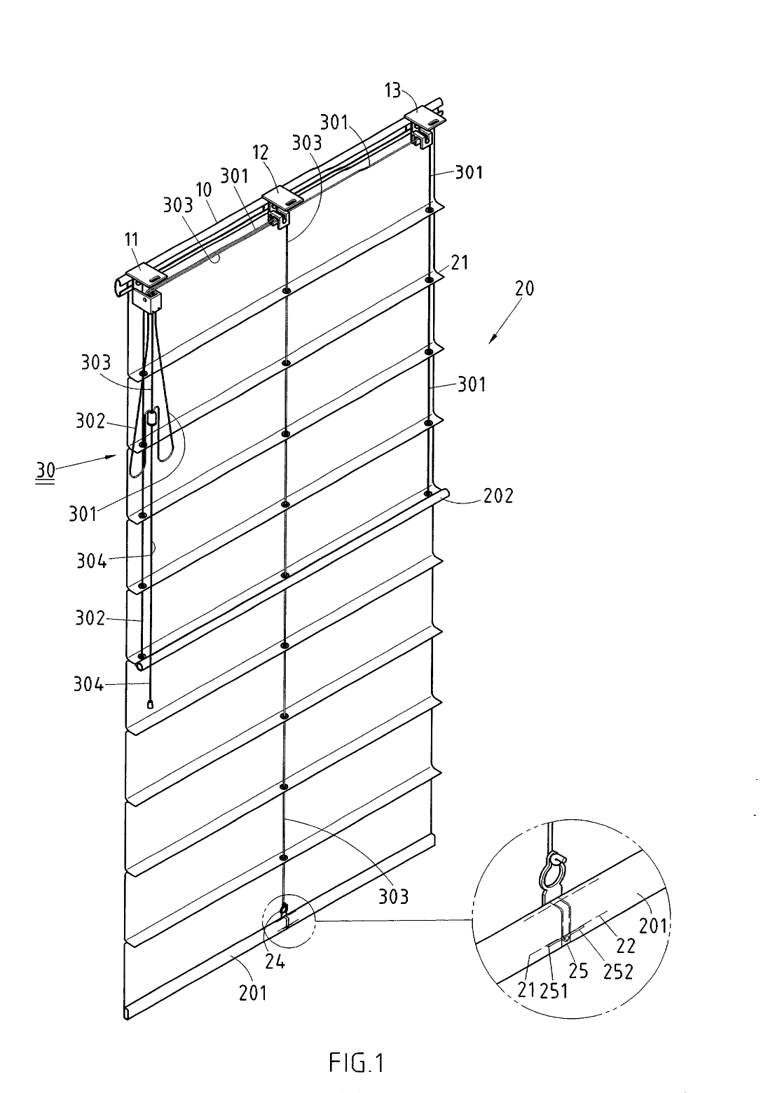

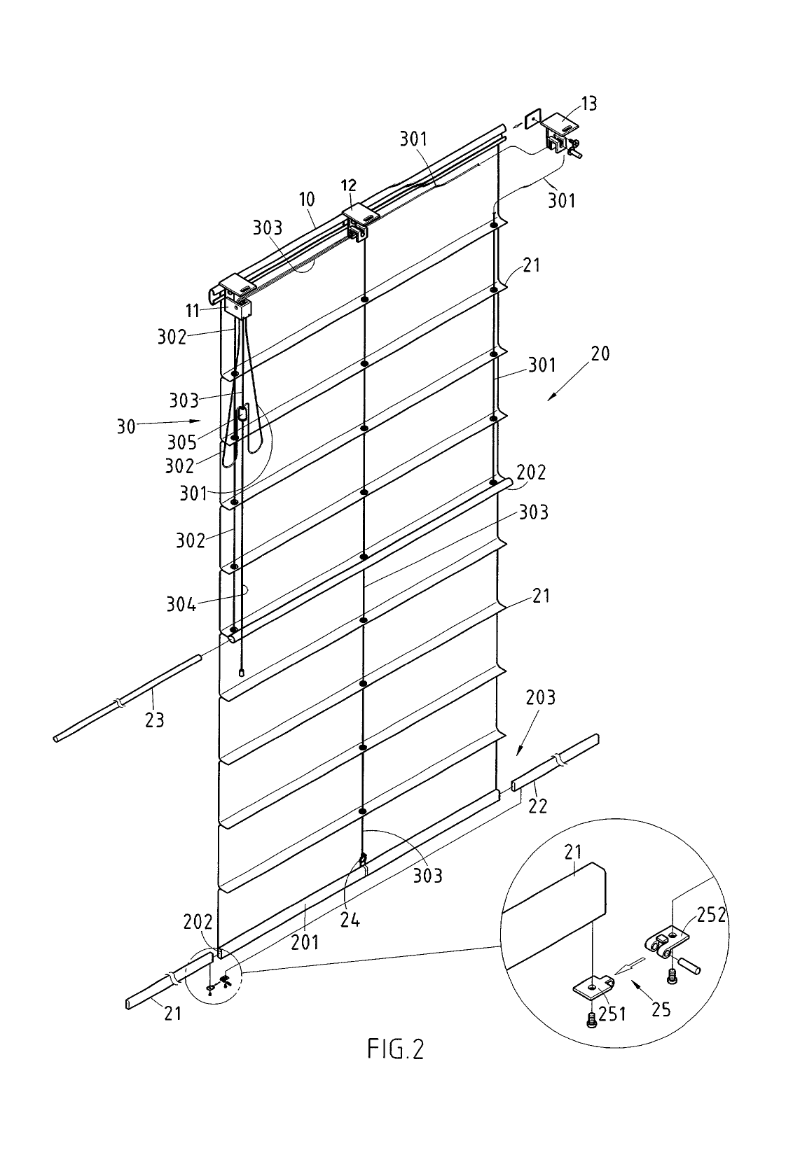

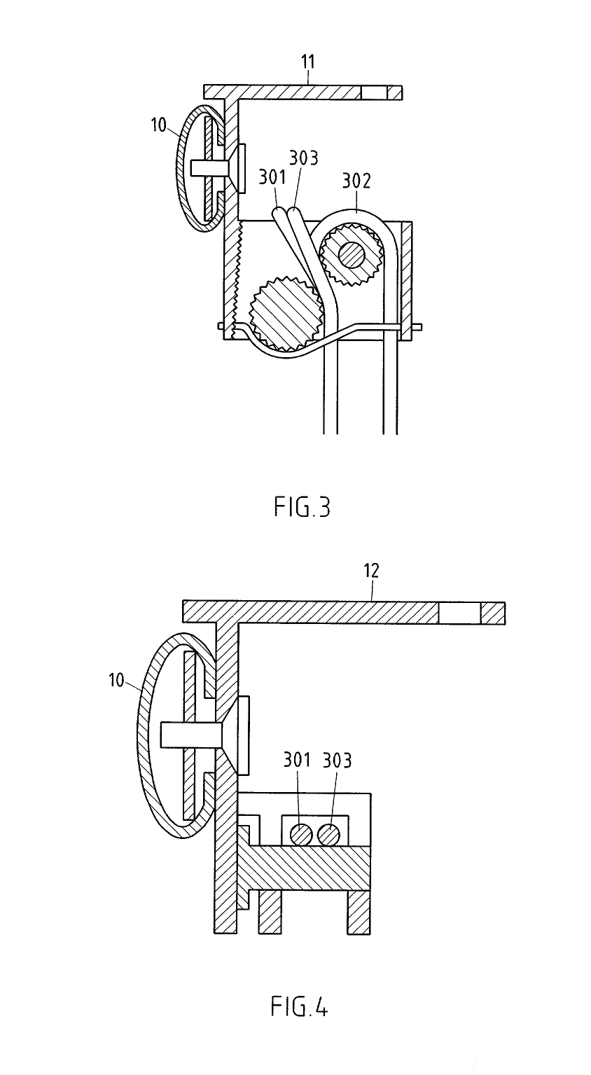

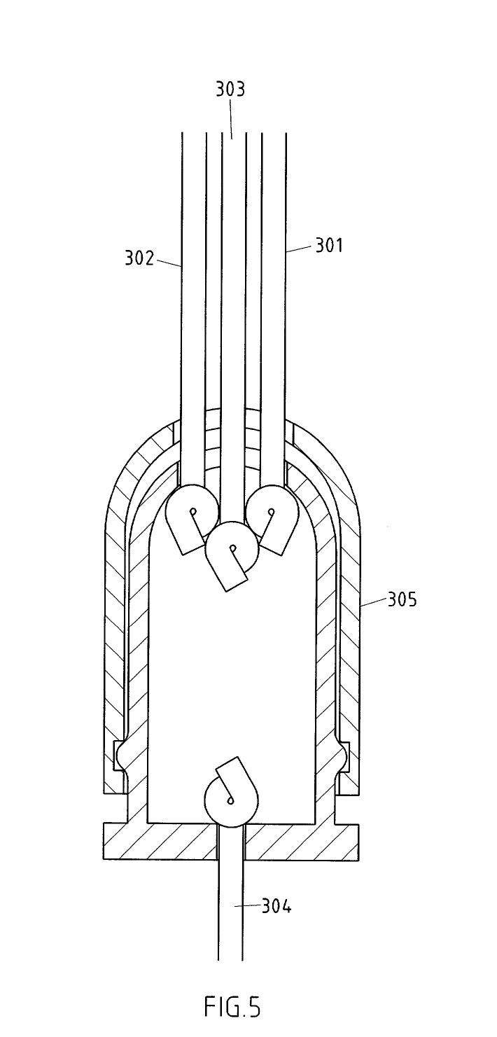

### DETAILED DESCRIPTION OF THE INVENTION

As shown in all drawings provided herewith, a window shade embodied in the present invention comprises a top rail 10, a pliable shade body 20, and a pull cord set 30.

The top rail 10 is provided at one longitudinal end with an arresting member 11, in the midsegment with a first actuating member 12, and at other longitudinal end with a second actuating member 13.

The shade body 20 is fastened at the top slide with the top rail 10 and is provided with a plurality of cross pleats 21 which are arranged at an interval and are parallel to the top rail 10. The shade body 20 is provided at the bottom side with a bottom tube 201, which has two longitudinal ends 202 and 203. The bottom tube 201 is provided with two bottom cross rods 21 and 22, which are fitted into the bottom tube 201 via the longitudinal ends 202 and 203. The shade body 20 is further provided in the midsegment with a middle tube 202, which is stitched in place and is provided with a middle cross rod 23 fitted thereinto. The middle tube 202 is parallel to the bottom tube 201 and the top rail 10.

The pull cord set 30 comprises two side pull cords 301 and 302, a middle pull cord 303, an active pull cord 304, and a locating member 305. When the shade body 20 is completed unfolded, the first side pull cord 301 is connected with the locating member 305 which is disposed under the arresting member 11 by an appropriate distance. The first side pull cord 301 is connected at other end with the middle tube 202 via the actuating members 12, 13, and a plurality of the cross pleats 21. The middle pull cord 305 is connected at one end with the locating member 305, and at other end with an annular body 24 of the bottom tube 201 via the arresting member 11 and the actuating member 12. The second side pull cord 302 is connected at one end with the locating member 305, and at other end with the middle tube 202 via the arresting member 11. The active pull cord 304 is fastened at the top end with the locating member 305.

The bottom tube 201 is provided as the center with a hinge 25 fastened therewith. The hinge 25 is provided with two connection pieces 251 and 252, which are connected respectively with the two bottom cross rods 21 and 22 of the bottom tube 201.

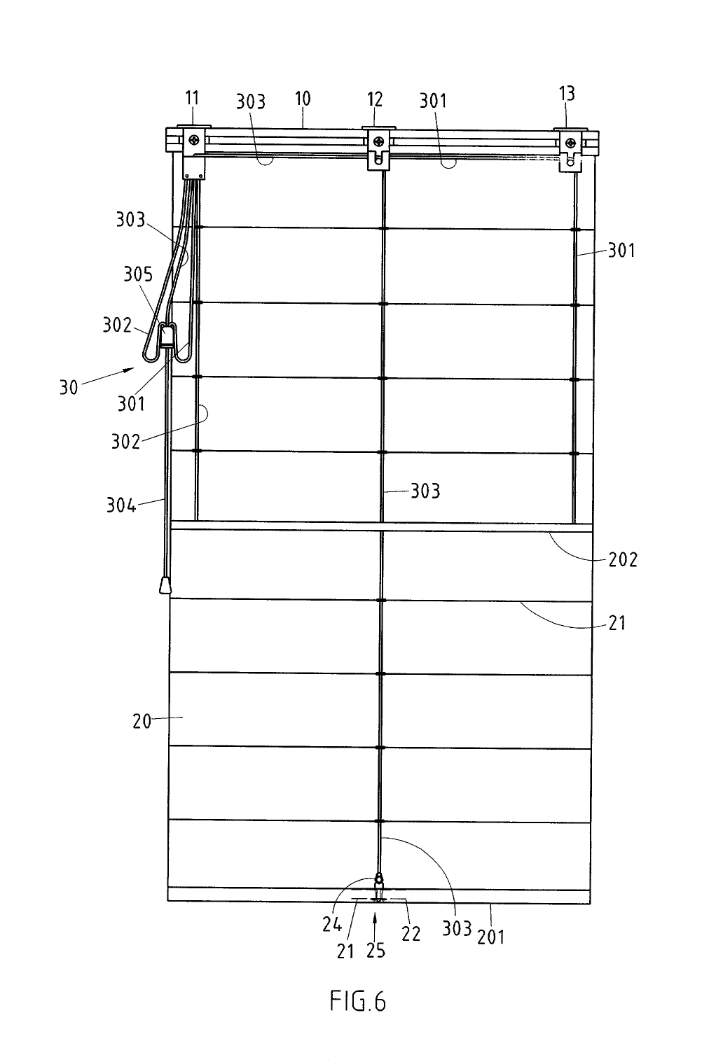

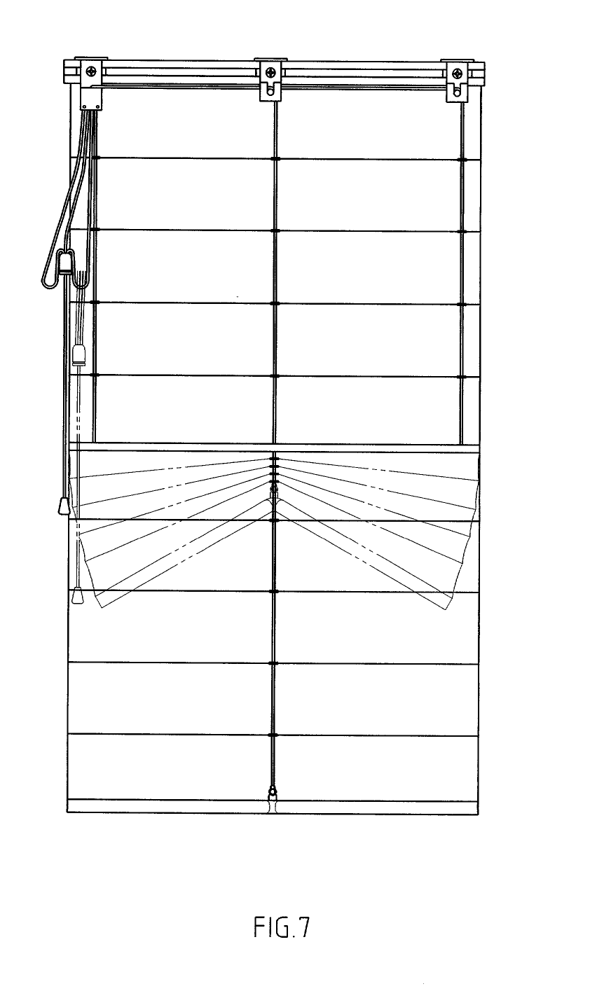

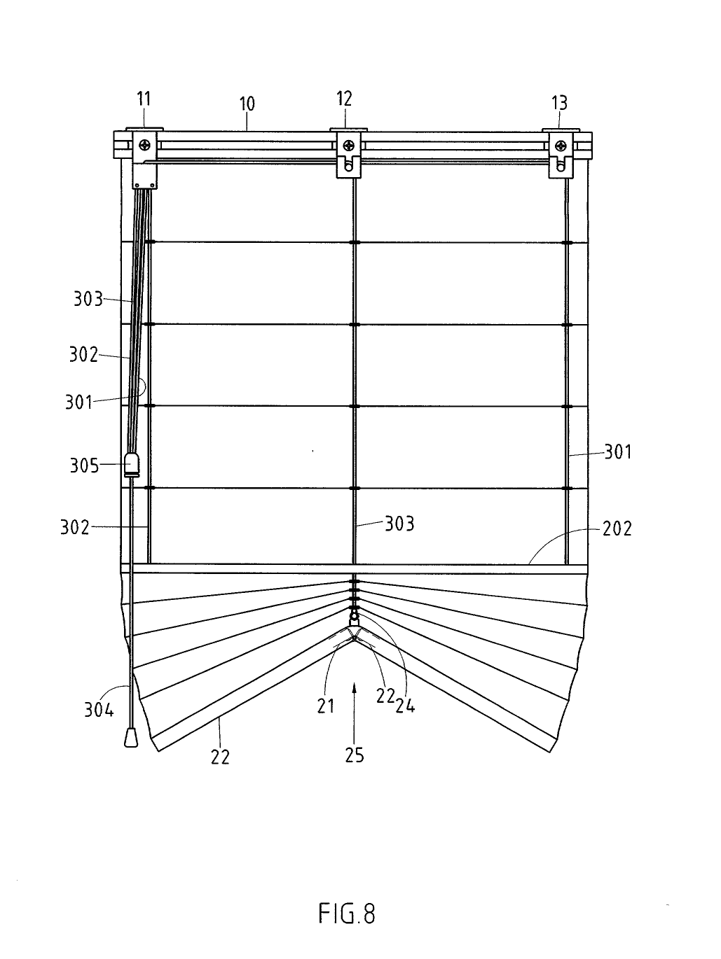

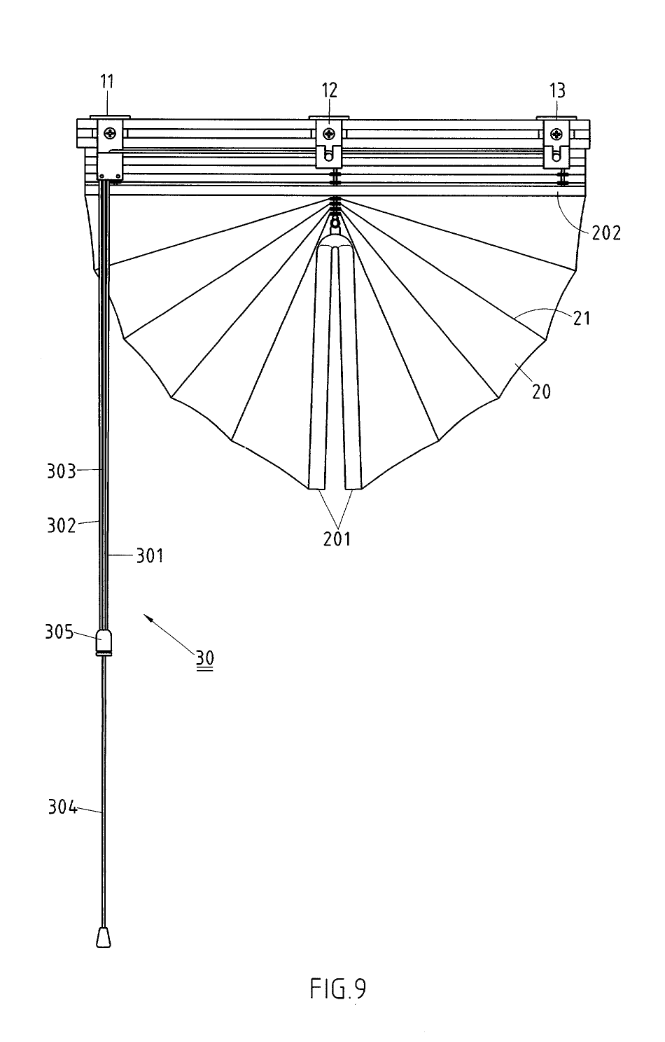

As illustrated in FIGS. 6-9, when the active pull cord 304 is pulled, the pull cords 301, 302 and 303 are linked by the locating member 305, thereby causing the bottom tube 201 to be lifted by the middle pull cord 303. In light of both longitudinal ends of the bottom tube 201 being burdened with the weights of the two bottom cross rods 21 and 22, the shade body 20 is caused to have an inverted sectional shape. As the active pull cord 303 is further pulled downward, the sectional portion of the shade body 20 is drawn to be near the middle tube 202. In the meantime, the middle tube 202 is actuated by the pull cords 301, 302, and 303 to move upward, thereby causing the shade body 20 above the middle tube 202 to fold.

I claim:

1. A window shade comprising:
a top rail having an arresting member, a first actuating member, and a second actuating member;
a shade body fastened at a top side with said top rail and provided with a plurality of cross pleats parallel to said top rail, said shade body provided at a bottom side with a bottom tube and two bottom cross rods fitted into said bottom tube, said shade body further provided in a midsegment with a middle tube which is provided with a middle cross rod fitted thereinto; and
a pull cord set comprising a first side pull cord, a second side pull cord, a middle pull cord, an active pull cord, and a locating member, said first side pull cord being connected at one end with said locating member which is located under said arresting member of said top rail by a distance, said first side pull cord being connected at other end with said middle tube of said shade body via said first actuating member, said second actuating member, and said cross pleats of said shade body, said middle pull cord being connected at one end with said locating member, and at other end with an annular body of said bottom tube of said shade body via said arresting member and said first actuating member, said second side pull cord being connected at one end with said locating member, and at other end with said middle tube via said arresting member, said active pull cord being fastened at a top end with said locating member.

2. The window shade as defined in claim 1, wherein said bottom tube of said shade body is provided at a center with a hinge fastened therewith whereby said hinge is connected with said two bottom cross rods of said bottom tube by two connection pieces.
